(19) United States
(12) Patent Application Publication
(10) Pub. No.: US 2006/0172231 A1
(43) Pub. Date: Aug. 3, 2006

(54) Use of an oxidizer to improve trace metals removal from photoresist and photoresist components

(75) Inventor: James M. Davidson, Corydon, IN (US)

Correspondence Address: Paul D. Greeley, Esq.;Ohlandt, Greeley, Ruggiero & Perle, LLP, One Landmark Square, 10th Floor, Stamford, CT, 06901-2682, US

(73) Assignee: FUJIFILM ELECTRONIC MATERIALS U.S.A., INC

(21) Appl. No.: 11/350,690

(22) Filed: Feb. 9, 2006

Related U.S. Application Data
(63) Continuation-in-part of application No. 10/215,266, filed on Aug. 8, 2002.

(51) Int. Cl. G03C 3/00

(52) U.S. Cl. 430/398

(57) ABSTRACT

A process of removing trace levels of metallic impurities from resist or photoresist component solutions and obtaining a purer resist or resist component solution without isolating the resist or resist component as a solid by treating the resist or resist component solution with an aqueous solution of a water soluble oxidizer, such as hydrogen peroxide, then with an acidic aqueous solution, and then allowing organic and aqueous phases to form with said aqueous phase containing metallic impurities extracted from said organic phase and the organic phase containing said resist or resist component solution with reduced amount of trace metal impurities, and separating the two phases.

### RELATED APPLICATION

This application is a continuation-in part of co-pending U.S. patent application Ser. No. 10/215,266, filed Aug. 8, 2002.

### FIELD OF THE INVENTION

The present invention relates to a process for removing trace levels of metallic impurities from a resist or photoresist component organic resist or photoresist organic solvent solution. In particular, the present invention is directed to a process of removing trace levels of metallic impurities from such resist or resist component solutions by treating the resist or resist component organic solution with a water soluble oxidizer, such as hydrogen peroxide, then with an acidic aqueous solution, and then allowing an organic phase and an aqueous phase to form with said aqueous phase containing metallic impurities extracted from said organic phase and the organic phase containing said resist or resist component solution with reduced amount of trace metal impurities, and separating the two phases.

### BACKGROUND TO THE INVENTION

Photoresist compositions are used in microlithographic processes for making miniaturized electronic components such as in the fabrication of integrated circuits and printed wiring board circuitry. Generally, in these processes, a thin coating or film of a photoresist composition is first applied to a substrate material, such as silicon wafers used for making integrated circuits or aluminum or copper plates of printed wiring hoards. The coated substrate is then baked to evaporate any solvent in the photoresist composition and to fix the coating onto the substrate. The baked coated surface of the substrate is next subjected to an image-wise exposure of radiation. This radiation exposure causes a chemical transformation in the exposed areas of the coated surface. Visible light, ultraviolet (UV) light, electron beam, and X-ray radiant energy are radiation types commonly used today in microlithographic processes. After this image-wise exposure, the coated substrate is treated with a developer solution to dissolve and remove either the radiation-exposed or the unexposed area of the coated surface of the substrate.

There are two types of photoresist compositions, negative-working and positive-working. When negative-working photoresist compositions are exposed image-wise to radiation, the areas of the resist composition exposed to the radiation become less soluble to a developer solution (e.g., a cross-linking reaction occurs) while the unexposed areas of the photoresist coating remain relatively soluble to a developing solution. Thus, treatment of an exposed negative-working resist with a developer solution causes removal of the nonexposed areas of the resist coating and the creation of a negative image in the photoresist coating, and thereby uncovering a desired portion of the underlying substrate surface on which the photoresist composition was deposited. On the other hand, when positive-working photoresist compositions are exposed image-wise to radiation, those areas of the resist composition exposed to the radiation become more soluble to the developer solution (e.g., a rearrangement reaction occurs) while those areas not exposed remain relatively insoluble to the developer solution. Thus, treatment of an exposed positive-working resist with the developer solution causes removal of the exposed areas of the resist coating and the creation of a positive image in the photoresist coating. Again, the desired portion of the underlying substrate surface is uncovered.

After this development operation, the now partially unprotected substrate may be treated with a substrate-etchant solution or plasma gases and the like. This etchant solution of plasma gases etch the portion of the substrate where the photoresist coating was removed during development. The areas of the substrate where the photoresist coating still remains are protected and thus, an etched pattern is created in the substrate material which corresponds to the photomask used for the image-wise exposure of the radiation. Later, the remaining areas of the photoresist coating may be removed during a stripping operation, leaving a clean etched substrate surface. In some instances, it is desirable to heat treat the remaining resist layer after the development step and before the etching step to increase it adhesion to the underlying substrate and its resistance to etching solutions.

Positive-working photoresists are generally prepared by blending a suitable alkali-soluble binder resin with a photoactive compound (PAC) which converts from being insoluble to soluble in an alkaline aqueous developer solution after exposure to a light of energy source. The most common class of PAC's employed today for positive-working resists are naphthoquinonediazide (DNQ) esters of a polyhydroxy compound.

Positive-working photoresist compositions are currently favored over negative-working resists because the former generally have better resolution capabilities and pattern transfer characteristics.

The quality of photoresists can be improved by substantially reducing the amount of contaminating metal ions in the photoresists. These metallic impurities include ions of iron, sodium, barium, calcium, magnesium, copper, and manganese as well as other metals. In positive-working resists, these impurities are mainly attributable to the binder resin component in the photoresist. The binder resin in positive-working resists is generally a phenolic formaldehyde novolak resin. Typical novolak resins used today for positive-working resins are made from various mixtures of cresols, xylenols, and trimethyiphenols which are condensed with an aldehyde source (e.g., formaldehyde). The contaminating metal ions get into these resins primarily as a result of their preparation process. Moreover, the free phenolic OH groups in novolak resins promote the incorporation of metal ions therein by proton exchange and by complexing on the polar groups. In other words, once metallic ion impurities get into a novolak resin, it is difficult to remove them.

Water washing of impure novolak resin dissolved in an organic solvent results in only a minor purifying effect. Similarly, techniques involving volatilization of the metal ions are impracticable.

The prior art is filled with numerous techniques for reducing the amount of metal impurities in photoresist components. Some of these teachings including the following:
1. U.S. Pat. No. 2,865,875, which issued to Hyman et al., on Dec. 23, 1958, is discussed with producing “low ash” phenol-formaldehyde resins and their preparation. Note that the patent teaches that phenol and formaldehyde may be reacted with two different types of alkaline catalysts (i.e., a fixed alkali metal catalyst such as caustic soda or a volatile nitrogen-containing catalyst such as ammonia). The patent states that a drawback to the use of the fixed alkali catalyst is the objectionable presence of the fixed alkali in the final resin. The patent described a prior an method for producing “filtered resins” which involved reacting phenol and formaldehyde with a mixed alkali and then after condensation has occurred, adding a precipitating acid such as phosphoric or oxalic acid. This causes a substantial part of the free alkali in the reaction mixture to be precipitated. That precipitate can then be filtered out. The Hyman et al. patent alleges that this prior art method always leaves behind residual traces of the salt formed which is high enough to adversely affect the quality of the product.
Hyman et al.'s invention instead involved (1) carrying out the phenol-formaldehyde condensation in a conventional manner with a fixed alkali catalyst; (2) then removing that fixed alkali catalyst in whole or in part by use of an cationic ion exchanger; and (3) and if pH of the resin solution goes below 4, adjusting the pH of the resin solution upward to pH 8 by addition of further alkali. Suitable cationic ion exchangers mentioned in the patent included Nalcite, Dowex, Amberlite, and Zeo Karb.
2. U.S. Pat. No. 3,067,172, which issued to Carlstrorn on Dec. 4, 1972, teaches removing metal from a phenol formaldehyde resole resin by passing a solution of that resin through a column of a cation exchange material which is insoluble in that solution and saturated with ammonium ions in exchanging position.
3. U.S. Pat. No. 3,432,453, which issued to Gladney et al. on Mar. 11, 1969, teaches a process for removing magnesium, barium or strontium ions from an aqueous solution of phenol-formaldehyde resin comprising (1) adding a soluble ammoninin salt (e.g., sulfate, phosphate or carbonate) to said aqueous solution in an amount to bring the pH of said solution to about 5.0 to 6.5, the anion of said ammonium salt capable of forming an insoluble salt with said Mg, Ba or Sr ions; and (2) then raising the pH to 7 of said aqueous solution by addition thereto of ammonia.
4. U.S. Pat. No. 4,033,909, which issued to Papa on Jul. 5, 1977 teaches the removal of ionic species from phenolic resoles by treatment thereof with the free acid form of a cation exchange resin and the hydroxyl form of a strongly basic anion exchange resin.
5. U.S. Pat. No. 4,725,523, which issued to Miura et al. on Feb. 16, 1988, teaches the addition of oxalic acid dihydrate to a novolak solution (see Synthesis Example No. 5, in column 4).
6. U.S. Pat. No. 5,073,622, which issued to Wojtech et al. on Dec. 17, 1991 and is assigned to Hoechst AG, claims process for the preparation of novolak resins having a reduced amount of metal ions, comprising the steps of: (1) dissolving a conventional novolak resin in an organic solvent or solvent mixture in a concentration of a bout 25 to 50% by weight and then (2) contacting the resultant solution at least once with an acidic compound (e.g., formic acid, acetic acid, oxalic acid, malonic acid, glycolic acid, lactic acid, tartaric acid, or citric acid).
7. U.S. Pat. No. 5,075,193, which issued to Dreselz et al. on Dec. 25, 1991, claims the use of microcrystalline cellulose to remove metal impurities from a solution of a naphthoquinonediazide DNQ compound by absorbing the DNQ compound into the microcrystalline cellulose.
8. U.S. Pat. No. 5,080,997, which issued to Hioki et al. on Jan. 14, 1992, claims a process for preparing a positive resist composition, which process comprise the steps of: reacting aquinone diazide sulfonyl halogenide with a phenol compound in a condensation reaction solvent to form a condensation reaction mixture; mixing the condensation reaction mixture with a solution of an alkali-soluble resin in a resist solvent without isolating aquinone diazide sulfonyl ester from the condensation reaction mixture to form a second mixture; evaporating said condensation reaction solvent from the second mixture to form a third mixture; washing the third mixture with water to form a fourth mixture; and evaporating the water from said fourth mixture to prepare said positive resist composition.
9. U.S. Pat. No. 5,116,315, which issued to Roland et al. on May 26, 1992, teaches the treatment of an aqueous solution of the sodium salt of 1,2-naphthoquinonediazidc-5-sulfonic add (5-DNQ) with a cationic ion exchange resin to make a free-acid 5-DNQ compound for use in making a capped novolak. See col. 8, lines 58-64.
10. U.S. Pat No. 5,378,802, which issued to Honda on Jan. 3, 1995, teaches a method of removing ionic impurities from a resist component, comprising the steps of: (a) dissolving said resist component in a solvent; (b) contacting said resist component solution with a fibrous ion exchange resin for a sufficient amount of time to remove at least a portion of said ionic impurities onto said fibrous ion exchange resin; and (c) separating said fibrous ion exchange resin bearing said ionic impurities from said resist component solution.
11. European Patent Application 0 251 187-A2, which was published on Jan. 7, 1988, claims a method for purifying novolak resins by (1) dissolving the novolak resin in a solvent having certain water-insolubility characteristics; (2) extracting the resulting solution with an acidic aqueous solution to reduce the metal content of the resin and then subjecting the resulting extracted solution to centrihigal separation.
12. Czechoslovakian Patent No. CS 259,458, which was published on Apr. 14, 1989, teaches that positive photoresist containing an o-naphthoquinone diazide sensitizer and a novolak resin in an organic solvent may be freed of salts and ions by treatment with anion and cation exchangers at 5-35° C.
13. U.S. Pat. No. 5,618,655, issued Apr. 8, 1997, teaches the use of a mixture of cyclohexane and isopropyl alcohol with an aqueous acidic solution to remove metal impurities from photoresist solutions containing trace metallic impurities.

Despite these many methods there remains a need for a further method of removing trace metal impurities that remain resistant to removal by the foregoing methods.

### SUMMARY OF THE INVENTION

An improved method for the removal of trace metal impurities from organic solvent solutions of resist or resist components, particularly diazanaphthoquinone (DNQ) capped novolak resin solutions, the method comprising treating the impure solutions with oxidizer and acidic aqueous solutions and allowing aqueous and organic phases to form, separating the two phases to provided a purer solution of resist or resist component or intermediates containing reduced amounts of trace metal impurities.

### DETAILED DESCRIPTION OF THE INVENTION AND PREFERRED EMBODIMENTS

The term “resist component” as used in the present specification and claims includes alkali-soluble resins such as novolak resins and polyvinyl phenol resins, photoactive compound as well as their precursors, and additives (e.g., speed enhancers, dyes, and the like) conventionally employed in photoresist compositions. This term also includes precursor compounds for making such components. One example of such precursor compounds would be back-bone compounds for making photoactive compounds as well as the precursor photoactive ester compounds (e.g., naphthoquinonediazide sulfonyl chlorides). The preferred class of resist components to be treated by the present invention is DNQ capped novolak resins because they generally contain a majority amount of the trace metal impurities in the resist.

The term “novolak resin” as used herein refers to any novolak resin which will dissolve completely in an alkaline developing solution conventionally used with positive-working photoresist composition. Suitable novolak resins include phenol-formaldehyde, novolak resins, cresol-formaldehyde novolak resins, xylenol-formaldehyde novolak resins, cresol-xylenol-formaldehyde novolak resins, preferably having a molecular weight of about 500 to about 40,000, and more preferably from about 800 to 20,000. These novolak resins are preferably prepared by the addition-condensation polymerization of a phenolic monomer or monomers (e.g., phenol, cresols, xylenols, or mixtures of such monomers) with an aldehyde source such as formaldehyde and are characterized by being light-stable, water-insoluble, alkali-soluble, and film-forming. One preferred class of novolak resins is formed by the addition-condensation polymerization between a mixture of m- and p-cresols with formaldehyde having a molecular weight of about 1,000 to about 10,000. Illustrative preparations of novolak resins are disclosed in U.S. Pat. Nos. 4,377,631; 4,529,682; and 4,587,196, all of which issued to Medhat Toukhy and are incorporated herein by reference in their entireties.

Other preferred novolak resins are illustrated in U.S. Pat. Nos. 5,145,763, 5,322,757 and 5,237,037. Their disclosures are also incorporated herein by reference in their entireties.

The term “photoactive compounds” as employed in the present specification and claims may include any conventional photoactive compound commonly used in photoresist composition. Quinonediazide compounds are one preferred class of photoactive compounds. Naphthoquinonediazide compounds are preferred class of species in that generic class. As mentioned above, photoactive compound precursors may be treated according to the present invention.

Photoresist additives may be treated according to the present invention. Such additives may include speed enhancers, dyes, and the like. One preferred speed enhancer is 1-[(1′-methyl-1′-(4′-hydroxyphenyl)ethyl)]4-[1′,1′-bis-(4-hydroxyphenyl)-ethyl]benzene (also known as TRISP-PA).

The term “impure resist or resist component solution” as used in the present specification and claims refers to solutions containing at least one trace metal impurity in an undesirable amount, preferably, more than 50 parts per billion (ppb) by weight.

The term “purer resist or resist component solution” as used in the present specification and claims refers to solutions containing at least one trace metal impurity in an amount of less than half of the amount originally present in the impure resist or resist component solution, preferably less than 30 parts per billion (ppb) by weight for each metal impurity.

In the process of this invention for removing trace metal impurities from an impure resist or resist component solution and obtaining a purer resist or resist component solution without isolating the resist or resist component as a solid, the process comprises the steps of:
(1) providing an impure resist or resist component solution of an impure resist or resist component containing trace amounts of metallic impurities in a solvent(s) wherein said solvent(s) is one selected from either:
   (a) resist or resist component organic solvent(s) or
   (b) organic solvent(s) having a lower boiling point than the resist or resist component organic solvent(s);
(2) contacting said impure resist or resist components solution with an aqueous solution of a water-soluble oxidizer and an aqueous acidic solution, and where the solvent(s) in step (1) is solvent (a), namely resist or resist component organic solvent(s), adding solvent (b), namely the lower boiling organic solvent(s), and permitting the resulting mixture to stand for a sufficient amount of time to form a two-phase mixture comprising an aqueous phase containing metallic impurities extracted from said impure resist or resist component solution and an organic phase containing said resist or resist component solution with a reduced amount of trace metal impurities;
(3) separating said aqueous phase from the organic phase and, when the solvent(s) in step 1 is the solvent (b), namely the lower boiling organic solvent(s), adding to the organic phase solvent (a) namely resist or resist component solvent(s); and
(4) removing said lower boiling organic solvent(s) from said organic phase, thereby forming a purer resist or resist component solution of resist or resist component in resist or resist component solvent(s) ready to use as a resist or resist component solution in forming a potoresist composition.

Preferably the process of the invention comprises the steps of:
(1) providing a resist or a resist component solution of an impure resist or resist component containing trace amounts of dissolved metallic impurities in a resist or resist component organic solvent;
(2) treating said impure resist or resist component solution with an aqueous solution of a water-soluble oxidizer and with an aqueous acidic solution, then adding thereto water and lower boiling, organic solvent(s) and permitting the resultant mixture to stand for a sufficient amount of time to form a two-phase mixture comprising an aqueous phase and an organic phase, said aqueous phase containing metallic impurities extracted from said organic phase and said organic phase containing said resist or resist component solution with reduced amount of trace metal impurities;
(3) separating said aqueous phase from said organic phase; and
(4) removing said lower boiling organic solvent(s) from said second organic phase, thereby forming a purer resist or resist component solution ready to use as a resist or resist component solution in forming a potoresist composition.

The process of the invention will be described hereinafter in detail and exemplified in regard to the preferred form of the invention, but the details are applicable to all forms of the invention.

In the process of the present invention, an impure resist or resist component solution dissolved in a suitable photoresist solvent, or photoresist solvent mixture is provided to facilitate the later contacting of the resist or resist component with the oxidizer solution and with the aqueous acidic solution. Examples of suitable resist or resist component dissolving solvents include, but are not limited to, methyl-3-methoxypropionate (MMP), ethyl lactate (EL), ethyl-3-ethoxy propionate (EEP), propylene glycol methyl ether acetate (PGMEA), 2-heptanone, propylene glycol methyl ether (PGME), or mixtures thereof and the like.

The solids contents of the impure resist or resist component solution is not critical. Preferably, the amount of solvent or solvents may be from about 50% to about 500%, or higher; by weight; more preferably from about 75% to about 400% by weight; based on the resist or resist component weight.

While it is preferred to use a single resist component as the material being treated by the method of the present process, it is contemplated within the scope of the present invention that combinations of resist components may be treated. For example, it may be desirable to treat a complete positive-working photoresist formulation (e.g., a combination of a novolak resin or resins, a photoactive compound such as quinonediazide sensitizer, and solvent or solvents as well as conventional optional minor ingredients such as dyes, speed enhancers, surfactants, and the like) according to the method of the present invention.

The impurities in the resist or resist component solution may be in the form of monovalent metal cations such as alkali metals (e.g., Na+ and K+) as well as divalent or trivalent cations (e.g., Ca+² Fe+², Fe+³, Cr+³ or Zn+²). Such metal impurities may also be in the form of colloidal particles such as insoluble colloidal iron hydroxides and oxides. Such metal impurities may come from the chemical precursors for the resist component (e.g., for novolak resins these may be phenolic monomers and aldehyde sources) as well as in the solvent used to make the solution. These impurities may also come from the catalysts used to make the resist components or from the equipment used for their synthesis or storage. Generally, the amount of metal impurities in a resist component such as a novolak resin prior to the present inventive process is the range from 50 ppb-5,000 ppb, or greater, by weight for metals such as sodium and iron. Sodium impurities are generally in the form of monovalent ions (Na+). The iron impurities are in the form of divalent and trivalent species (Fe+² and Fe+³) as well as insoluble colloidal iron species (e.g., iron hydroxides and oxides). The resist component impurities may also include anionic impurities such as halides (e.g., Cl⁻, F⁻, Br⁻). The process is especially beneficial for removal of mutivalent metallic impurities, i.e. metals having more than one valence state, such as for example iron (Fe+² and Fe+³) and chromium (Cr+², Cr+³ and Cr+⁶).

The impure resist or resist component solutions may be made in any conventional method of mixing a resist component with a resist solvent. Generally, it is preferred that the resist component is added to a sufficient amount of resist solvent so that the resist component is dissolved in the solvent. This step may be facilitated by agitation or other conventional mixing means.

The next step in the process of the present invention is contacting the resist or resist component solution with a water soluble oxidizer, such as hydrogen peroxides, hydroperoxides, alkyl peroxides and organic peroxides, preferably hydrogen peroxide. Any suitable water-soluble oxidizer that would not introduce undesirable metal impurities into the solution may be employed, such as for example, those mentioned above as well as, but not limited to t-butyl hypochlorite, t-butyl hydroperoxide, peracetic acid, perpropionic acid, and hypochlorous acid.

The impure solution of resist or resist components and water-soluble oxidizer are mixed under agitation for a period of time sufficient to provide intimate contact of the oxidizer with the metal impurities.

The impure resist or resist component solution is then also contacted with an acidic aqueous solution that assists extraction of at least a portion of the metallic impurities out of the impure resist component solutions. Alternatively, the impure resist or resist component solution may be contacted or treated with the oxidizer and acid aqueous solution simultaneously, e.g., with an aqueous solution of both the oxidizer and acid. However, the preferable mode of treatment is to treat the impure resist or resist component solution first with the water-soluble oxidizer and then with the acidic aqueous solution.

The acids employed in the aqueous acid solution may be any suitable inorganic or organic acid. Particularly preferred as acids with complexing properties. Preferable inorganic acids include mineral acids such as hydrochloric acid, sulfuric acid, or phosphoric acid. Preferable organic acids are those soluble in water and include low molecular weight carboxylic acids such as formic acid, acetic acid, oxalic acid, malonic acid, glycolic acid, lactic acid, tartaric acid, and citric acid. Oxalic acid is particularly preferred.

Another particularly preferable class of acidic extracting compounds include acidic chelating agents such as nitrilotriacetic acid, ethylene-dinitrilo-tetraacetic acid, 1,2-cyclohexylene-dinitrilo-tetraacetic acid, diethylene-triamine-pentaacetic acid, and 3,6-dioxaocta-methylenedinitrilo-tetraacetic acid. Additional acidic extracting agents for metal ions include acidic esters of phosphoric acid, phosphonic acid, and phosphenic acid.

The amount of acid in the aqueous solution will depend upon the type of acid employed, the amount of extractable metals present in the resist or resist component, and other factors. If oxalic acid is the acid employed, the preferred amount of oxalic acid in the aqueous solution may be from about 0.01% to about 10%; more preferably, about 0.1% to 1% by weight of the aqueous phase of that solution. If HCl is employed, the preferred amount of HCl may range from about 0.01% to about 2%; more preferably, from about 0.1% to about 1% by weight. If EDTA is employed, the preferred amount of EDTA in the aqueous solution may range from about 200-800 parts per million parts of aqueous solution.

The relative amounts of the impure resist or resist component solvent to the total amount of oxidizer may preferably range from about 10,000:1 to 20:10 weight ratio. More preferably, weight ratios from 1000:1 to 100:1 may be used.

Preferably, the relative amounts of organic phase (i.e., total amount of impure resist component solution plus the amount of resist or photoresist component solvent) and the aqueous phase (i.e., aqueous oxidizer solution and aqueous acidic solution) may range from about 95:5 to about 50:50 by weight organic phase to aqueous phase.

The aqueous oxidizer solution and aqueous acidic solution contacting may be effected in any form of liquid-liquid contacting, such as for example, simple mixing in a container or vessel with stirring. Contacting is preferably obtained in a single-stage or multi-stage cross-flow or counter current treatment.

This contacting or washing step may be carried out in any suitable apparatus, including the reactor in which the resist component was formed. Generally, the aqueous oxidizer solution and aqueous acidic solution are added to the resist component solution and the resulting mixture is agitated for a sufficient amount of time to obtain a thorough mixing of these liquids (e.g., from about 15 to 120 minutes up to 24 hours). Then, additional lower boiling (lower than the resist or photoresist component solvent boiling temperature), organic solvent is added to the mixture in the apparatus. The additional solvent(s) to be added serve to increase the overall hydrophobicity of the organic phase, increase the density difference of the organic phase from the density of the aqueous phase in order to improve the separation of the mixture into only two phases, namely an aqueous phase and an organic phase. Thus, the particular lower boiling organic solvent(s) employed will depend on the resist or resist component and the solvent(s) in which it is dissolved. Preferably, the lower boiling organic solvent(s) added to the mixture provides a mixture in which the aqueous phase is heavier. Any suitable lower boiling organic solvent suitable for providing these effects may be employed and will be selected for compatibility with the other components in the mixture. It is also preferred that the lower boiling organic solvent(s) have boiling points enough lower than the resist component solvent so that the lower boiling organic solvent(s) are readily removed by stripping and the resist components remain in the organic phase. Examples of such lower boiling organic solvents include, but are not limited to, acetone, hexane, heptane, cyclohexane, isopropylacetate, ethyl acetate, methyl t-butyl ether, methylethylketone and higher ketones. The mixture is then allowed to sit for a sufficient time of from about 15 minutes up to about 24 hours or longer, preferably, for about 15 to 120 minutes or up to about 24 hours) to form a two-phase mixture with the organic solvent layer on top and the aqueous layer on bottom.

Next, the aqueous phase is separated from the organic phase. This is preferably accomplished by draining the heavier aqueous phase from the bottom of the vessel containing the overall liquid mixture.

If desired, additional water optionally along with additional replacement organic resist or resist component solvent and/or additional lower boiling organic solvent to replace lower boiling organic solvent that may have been extracted in the aqueous phase may be added to the separated organic phase, with agitation, and once again permitted to be in contact for a period of generally from about 15 minutes to about 24 hours or longer, preferably about 15 to about 120 minutes, again followed by separation of the resulting new aqueous and organic phases. Then, the second aqueous phase is separated from this second organic phase. Again, this is preferably accomplished by simply draining the aqueous phase from the bottom of the vessel containing the total liquid mixture. This step may be repeated as often as deemed necessary.

The amount of replacement resist component solvent in the water/resist component solvent mixture should be sufficient to replace the replacement solvent (e.g., ethyl lactate) extracted into the first aqueous phase (i.e., to reestablish the proper dissolving solvent concentration in the separated first organic phase).

The preferable relative amounts of separated organic phase to the water/resist component solvent phase is from about 95:5 to about 70:30, The preferred relative amounts of water to replacement resist or resist component solvent may range from about 10:1 to about 1:10 by weight.

Finally, the lower boiling organic solvent(s) in the separated organic phase is separated from the resist component in the organic phase. This separation is preferably carried out by a conventional solvent stripping operation. After the removal of excess solvent, the resist component is left in a remaining amount of the resist component solvent or solvents.

The preferred stripping operation is generally carried out under vacuum at a temperature less than 100° C. Alternatively, the lower boiling solvent(s) may be stripped using thin film evaporation and other conventional solvent stripping techniques.

Preferably, in the case of a novolak resin, it is desirable to strip the lower boiling solvent(s) to leave a purified resist component solution having about 38-43% by weight solids content and then add more resist component solvent to form a 25-36% by weight solids content.

Through the utilization of the present process, the metal ion content is reduced by a major portion (i.e., 50% or more by weight) for at least one metal impurity and preferably by two to three decimal places for all metal impurities and, as a result, materials can be prepared which meet the stringent requirements in microelectronics.

Accordingly, purer resist component solutions such as novolak resin solutions can be prepared by the present process, which have an amount of sodium ions and iron ions as indicator metal cations under about 20 ppb and under about 20 ppb, respectively. Preferably, the novolak resins have an amount of sodium ions and iron ions under about 10 ppb and under about 10 ppb, respectively. Particularly preferably, the amounts of sodium ions and iron ions are under about 0.2 ppb and 1 ppb, respectively.

Alternatively, the impure resist or resist component to be purified can be provided dissolved in the lower boiling organic solvent(s), then treated with the water-soluble oxidizer and acidic aqueous solution as previously described and then separate the resulting organic and aqueous phases to reduce the metal impurities, and then add resist or resist component solvent to the organic phase and strip of the lower boiling solvent(s) therefrom.

The present invention is further described in detail by means of the following Example and Comparisons. All parts and percentages are by weight and all temperatures are degrees Celsius unless explicitly stated otherwise.

### EXAMPLE

### Purification of a Capped Novolak Resist

A jacketed 20-liter resin kettle equipped with an agitator and a bottom valve was charged with a DNQ capped novolak resist prepared using 2395.03 grams of meta-cresol novolak (MW about 6000) partially capped with a 1,2-naphthoquinone-2-diazide-5-sulfonyl moiety, 75.17 grams of acetic acid, 75.17 grams surfactant, 528.66 grams of a 3:1 copolymer of methyl methacrylate:methacrylic acid copolymer (MW=7000), 293.7 grams meta-xylene-4-6-disulfonanilide, 386.35 grams of the 1,2-naphthoquinone-2-diazide-5-sulfonate tris ester of 1,3,5-benzenetriol and 5749.92 grams ethoxyethyl propionate (EEP). The DNQ capped novolak resist contained 328 ppb iron and 60 ppb chromium.

Typical procedures for synthesis of DNQ capped novolaks are known to those skilled in the art. Examples of such syntheses can be found in U.S. Pat. No. 5,225,311, U.S. Pat. No. 5,478,691, and U.S. Pat. No. 5,145,763 and generally entail the reaction of the a solvated novolac with 1,2-naphthoquinone-2-diazide-5-sulfonyl chloride or 1,2-naphthoquinone-2-diazide-4-sulfonyl chloride under basic conditions.

47.5 grams of 50% aqueous hydrogen peroxide were added to the DNQ capped novolak resist concentrate and the mixture was agitated for about 20 minutes.

475.2 grams of 7% aqueous oxalic acid were added to the kettle and the mixture was agitated at room temperature for about 16 hours.

After agitating for about 16 hours, 2978 grams of EEP, 1520 grams of acetone, and 1520 grams of hexane were added to the kettle. The mixture was agitated for about 5 minutes.

2850 grams of de-ionized water were added and the mixture was agitated for about 5 minutes.

Agitation was stopped and the phases were allowed to separate for about 24 hours.

2418 grams of bottom (aqueous) layer were removed from the kettle and 760 grams of acetone and 2850 grams of de-ionized water were added to the kettle. The mixture was agitated for about 5 minutes.

Agitation was stopped and the phases were allowed to separate for about 2 hours.

3358 grams of bottom (aqueous) layer were removed from the kettle and 760 grams of acetone and 2850 grams of de-ionized water were added to the kettle. The mixture was agitated for about 5 minutes.

Agitation was stopped and the phases were allowed to separate for about 1 hour.

4038 grams of bottom (aqueous) layer were removed from the kettle and 760 grams of acetone and 2850 grams of de-ionized water were added to the kettle. The mixture was agitated for about 5 minutes.

Agitation was stopped and the phases were allowed to separate for about 1 hour.

3132 grams of bottom (aqueous) layer were removed from the kettle.

A condenser and receiver connected to a vacuum source were added to the resin kettle and hot water (60° C.) was circulated through the jacket to strip off part of the hexane, acetone, EEP, residual water.

After this initial stripping, the remaining material in the resin kettle was transferred in portions to a rotary vacuum system to vacuum strip off the remaining hexane, acetone, and residual water along with some EEP.

The stripped portions were combined, analyzed for % solids, and EEP was added to adjust the final % solids. The final treated and adjusted product had 38.8% solids, 49 ppb iron, 23 ppb chromium.

### COMPARATIVE PROCESS EXAMPLES

In contrast, several standard techniques were tried, unsuccessfully to sufficiently reduce iron in the capped novolak resist of Example 1.

AMMION (the ammonium salt of a sulfuric acid ion exchange resin) and CR-20 (an amine based chelating resin) were added to a sample of the capped novolak resist of Example 1 (1 wt. % of each), the sample was rolled for several days, and the ion exchange resins were removed by filtration. This treatment had little or no effect on iron concentration (270 ppb),

A sample of the capped novolak resist of Example was treated with an aqueous oxalic acid solution (228 grams sample, 14.3 grams 7% oxalic acid solution, and 85.7 grams of DI water). After agitating for several minutes, resist solvent (EEP), acetone and hexane were added to the mixture and the agitation was stopped to allow the phases to separate. The bottom (aqueous) phase was removed and the top (organic) phase was washed twice with DI water. Hexane, acetone, residual water, and some EPP were removed by stripping under vacuum. This treatment reduced iron in the the capped novolak resist of Example to 133 ppb. The results from this comparative example shows that the prior art process reduced the trace iron contamination by 59%, whereas the inclusion of the oxidizer according to the process of this invention improved the removal of the iron contamination to 85%.

A sample of the capped novolak resist of Example was treated with CDTA (diaminocyclohexane N,N,N′,N′-tetraacetic acid), a chelating compound. The CDTA was removed by washing with DI water in a procedure similar to the oxalic acid treatment. This treatment reduced iron to 156 ppb.

A sample of the capped novolak resist of Example was washed with DI water in a procedure similar to the procedure above except with no additive (oxalic acid). This washing reduced iron to 154 ppb.

While the invention has been described above with reference to specific embodiments thereof, it is apparent that many changes, modifications, and variations can be made without departing from the inventive concept disclosed herein. Accordingly, it is intended to embrace all such changes, modifications, and variations that fall within the spirit and broad scope of the appended claims. All patent applications, patents, and other publications cited herein are incorporated by reference in their entirety.

What is claimed is:

1. A process for removing trace metal impurities from an impure resist or resist component solution and obtaining a purer resist or resist component solution without isolating the resist or resist component as a solid, the process comprising the steps of:
(1) providing an impure resist or resist component solution of an impure resist or resist component containing trace amounts of metallic impurities in a solvent(s) wherein said solvent(s) is one selected from either:
(a) resist or resist component organic solvent(s) or
(b) organic solvent(s) having a lower boiling point than the resist or resist component organic solvent(s);
(2) contacting said impure resist or resist components solution with an aqueous solution of a water-soluble oxidizer and an aqueous acidic solution, and where the solvent(s) in step (1) is solvent (a), namely resist or resist component organic solvent(s), adding solvent (b), namely the lower boiling organic solvent(s), and permitting the resulting mixture to stand for a sufficient amount of time to form a two-phase mixture comprising an aqueous phase containing metallic impurities extracted from said impure resist or resist component solution and an organic phase containing said resist or resist component solution with a reduced amount of trace metal impurities;
(3) separating said aqueous phase from the organic phase and, when the solvent(s) in step 1 is the solvent (b), namely the lower boiling organic solvent(s), adding to the organic phase solvent (a) namely resist or resist component solvent(s); and
(4) removing said lower boiling organic solvent(s) from said second organic phase, thereby forming a purer resist or resist component solution of resist or resist component in resist or resist component solvent(s) ready to use as a resist or resist component solution in forming a potoresist composition.

2. A process of removing trace metal impurities from an impure resist or resist component solution and obtaining a purer resist or resist component solution without isolating the resist or resist component as a solid, the process comprising the steps of:
(1) providing a resist or a resist component solution of an impure resist or resist component containing trace amounts of dissolved metallic impurities in a resist or resist component organic solvent;
(2) treating said impure resist or resist component solution with an aqueous solution of a water-soluble oxidizer and with an aqueous acidic solution, then adding thereto water and lower boiling, organic solvent(s) and permitting the resultant mixture to stand for a sufficient amount of time to form a two-phase mixture comprising an aqueous phase and an organic phase, said aqueous phase containing metallic impurities extracted from said organic phase and said organic phase containing said resist or resist component solution with reduced amount of trace metal impurities;
(3) separating said aqueous phase from said organic phase; and
(4) removing said lower boiling organic solvent(s) from said second organic phase, thereby forming a purer resist or resist component solution ready to use as a resist or resist component solution in forming a potoresist composition.

3. The process of claim 2 wherein said resist component comprises a DNQ capped novolak resin.

4. The process of claim 3 wherein said resist component solvent is a mixture of ethyl lactate and eth-3-ethoxypropionate.

5. The process of claim 4 wherein said resist component solvent is a mixture of ethyl lactate and eth-3-ethoxypropionate.

6. The process of claim 2 wherein said metallic impurities removed from the resist component solution comprise a metal with more than one valence state.

7. The process of claim 3 wherein said metallic impurities removed from the resist component solution comprise a metal with more than one valence state.

8. The process of claim 2 wherein said impure resist component solution contains at least one trace metal impurity in an amount of more than 50 parts per billion (ppb) by weight.

9. The process of claim 2 wherein the amount of each trace metal impurity in said purer resist component solution is less than 30 parts per billion (ppb) by weight.

10. The process of claim 3 wherein said impure resist component solution contains at least one trace metal impurity in an amount of more than 50 parts per billion (ppb) by weight.

11. The process of claim 3 wherein the amount of each trace metal impurity in said purer resist component solution is less than 30 parts per billion (ppb) by weight.

12. The process according to claim 2 wherein the trace metal impurity is selected from the group consisting of iron and chromium, the oxidizer is selected from the group consisting of hydrogen peroxide and hypochlorous acid, and the resist component comprises a DNQ capped novolak resin.

13. The process of claim 12 wherein the acid in said aqueous acid solution is oxalic acid and the oxidizer is hydrogen peroxide.

14. The process according to claim 13 wherein the lower boiling organic solvent(s) in step (3) comprises acetone and hexane.
